(19) United States
(12) Patent Application Publication
(10) Pub. No.: US 2011/0012455 A1
(43) Pub. Date: Jan. 20, 2011

(54) Bearing

(76) Inventor: Edward Docherty Scott, Fife (GB)

Correspondence Address: RICHARD A. FAGIN, P.O. BOX 1247, RICHMOND, TX, 77406-1247, US

(21) Appl. No.: 12/837,635

(22) Filed: Jul. 16, 2010

(30) Foreign Application Priority Data
Jul. 16, 2009 (GB) 0912354.8

(51) Int. Cl. H02K 7/08; F16C 17/00; F16C 33/58; F16C 19/30

(52) U.S. Cl. 310/90; 384/129; 384/615; 384/606

(57) ABSTRACT

A bearing (10) for use in a downhole motor assembly having an inner race (12) formed as a unitary construction. The inner race (12) has an inner surface (14) defining a first diameter (D1) and an outer surface (16) defining an second diameter (D2) and a number of race-ways (18). The bearing (10) also has an outer race (20) having an inner surface (22) defining a first diameter (D3), an outer surface (26) defining a second diameter (D4) and a number of race-ways (28). Bearing elements (30) are provided in the raceways (18, 28) to couple the inner race (12) and the outer race (20) such that, in use, the inner race (12) and the outer race (20) can rotate relative to each other. The inner race (12) of the bearing (10) is configured so that an inner diameter of the inner race is outside a drill through of a downhole motor assembly.

### CROSS REFERENCE TO RELATED APPLICATIONS

Priority is claimed from British Patent Application No. 0912354.8 filed on Jul. 16, 2009.

### STATEMENT REGARDING FEDERALLY SPONSORED RESEARCH OR DEVELOPMENT

Not Applicable

### FIELD OF THE INVENTION

This invention relates to a bearing and, in particular, but not exclusively, to a bearing for a downhole or wellbore tool.

### BACKGROUND TO THE INVENTION

In the creation of a borehole, such as may be utilised in the oil & gas production industry to access a hydrocarbon-bearing formation, a number of types of drilling motor systems have been developed for use in the drilling of the borehole. These include, for example, turbines, positive displacement motors or other motor operating on the Moineau Principle, rotary vane motors, downhole electric motors, and the like. In some instances, the wellbore fluid, such as drilling mud or other available hydraulic fluid, may be used as a motive source to rotate and drive a drill bit used to create the bore.

Each type of motor system has various advantages and limitations, a result of which is that no single type of motor system has an overwhelming advantage over another in drilling a wellbore or borehole.

Typically, a drilling motor is designed to run at very high rotational speeds, perhaps up to about 1000 rpm, although higher or lower speeds may be required according to the circumstances. Such high rotational speeds may be deemed necessary to achieve the required drive torque to permit a drill-bit, such as a diamond drill-bit, to drill through a rock formation to create the bore.

All of these motor systems require the inclusion of a bearing system to carry thrust loading and/or radial loading during rotation. In some instances, the bearing system utilises drilling fluid lubricated plain thrust and radial journal bearings or mud lubricated or sealed ball thrust bearings. There have also been developments in producing a bearing system which utilises tapered roller bearing elements in a sealed environment. In both plain thrust and thrust ball bearing systems, each race or disc of the bearing may be a discrete component, that is, a series of individual component parts.

In some circumstances, it may necessary or desirable to drill through the motor system, for example where the borehole is to be extended.

EP1,989,390A describes a drillable motor system where, on completion of drilling and cementing operations in the borehole, the internal machine components of the motor system may be drilled-through.

However, it has been found that the bearing systems, such as plain radial journal bearings or plain axial thrust bearings, represent a significant amount of material to be drilled through, this adding to the drill through duration, thereby adding to the cost and risk assocaited with drill through operations.

### SUMMARY OF THE INVENTION

According to a first aspect of the present invention, there is provided a bearing for a downhole motor assembly, the bearing comprising an inner race having an inner diameter configured so as to be outside a drill through diameter of the motor assembly.

Embodiments of the present invention represent an improved bearing for a downhole drilling motor assembly in which the inner race of the bearing is outside the diameter of a drill through diameter used to drill through the internals of a drilling motor of a downhole motor assembly.

The inner race of the bearing may be formed as a unitary construction.

The inner race may be constructed from any sutiable material. In particular embodiments, the inner race may be constructed from a hardened material.

Accordingly, the inner race may be configured to provide a rigid support for the bearing, retaining structural integrity even where the internal components of the assembly are removed by a drill through operation.

The inner race may comprise an inner surface defining a first diameter and an outer surface defining a second diameter.

The inner race may comprise at least one race-way. In particular embodiments, the inner race may comprise a plurality of race-ways. Where a plurality of race-ways are provided, the race-ways may be provided at axially distributed locations on the inner race.

The bearing may further comprise an outer race and the outer race may comprise an inner surface defining a first diameter and an outer surface defining a second diameter.

The outer race may further comprise at least one race-way. In particular embodiments, the outer race may comprise a plurality of race-ways. Where a plurality of race-ways are provided, the race-ways may be provided at axially distributed locations on the outer race.

The outer race of the bearing may comprise a unitary construction. Alternatively, the outer face of the bearing may comprise a plurality of components.

The bearing may be of any suitable construction. In some embodiments, the bearing may comprise a ball bearing, for example a thrust ball bearing. Alternatively, or in addition, the bearing may comprise a radial ball bearing and/or the combination of a radial and thrust ball bearing. In particular embodiments, the bearing may comprise a 4 point contact bearing.

The bearing may permit bi-directional axial loading or uni-axial directional loading.

The bearing may further comprise at least one bearing element and, in particular embodiments, the bearing may comprise a plurality of bearing elements. The bearing element may comprise any suitable element and, in particular embodiments, the bearing element may comprise at least one ball.

The balls may be provided in the race-ways to couple the inner race and the outer race such that, in use, the inner race and the outer race can rotate relative to each other.

The bearing may further comprise a bearing housing and the outer surface of the outer bearing race may be secured to the housing.

The bearing may further comprise a sealing arrangement. The sealing arrangement may be of any suitable form. In particular embodiments, the sealing arrangement comprises one or more annular seal element. The bearing may comprise a hardened seal running surface.

In use, bearings according to embodiments of the present invention may be constructed to carry radial loading and/or uni-directional or bi-directional axial loading.

The bearing may be either drilling fluid lubricated or lubricated by lubrication oils or grease in a sealed pressure compensated environment.

According to a second aspect of the present invention, there is provided a downhole motor assembly comprising:

a rotary drive;

a cutting element; and

a bearing according to the first aspect of the present invention.

It should be understood that the features defined above in accordance with any aspect of the present invention may be utilised, either alone or in combination with any other defined feature, in any other aspect of the invention.

### BRIEF DESCRIPTION OF THE DRAWINGS

These and other aspects of the present invention will now be described, by way of example only, with reference to the accompanying figures, in which:

FIG. 1 is a longitudinal sectional view of a bearing according to a first embodiment of the present invention;

FIG. 2 is a longitudinal sectional view of a downhole motor assembly comprising the bearing of FIG. 1;

FIG. 3 is an enlarged view of an end section of the bearing shown in FIGS. 1 and 2; and

FIG. 4 is a longitudinal sectional view of a bearing according to a second embodiment of the present invention.

### DETAILED DESCRIPTION

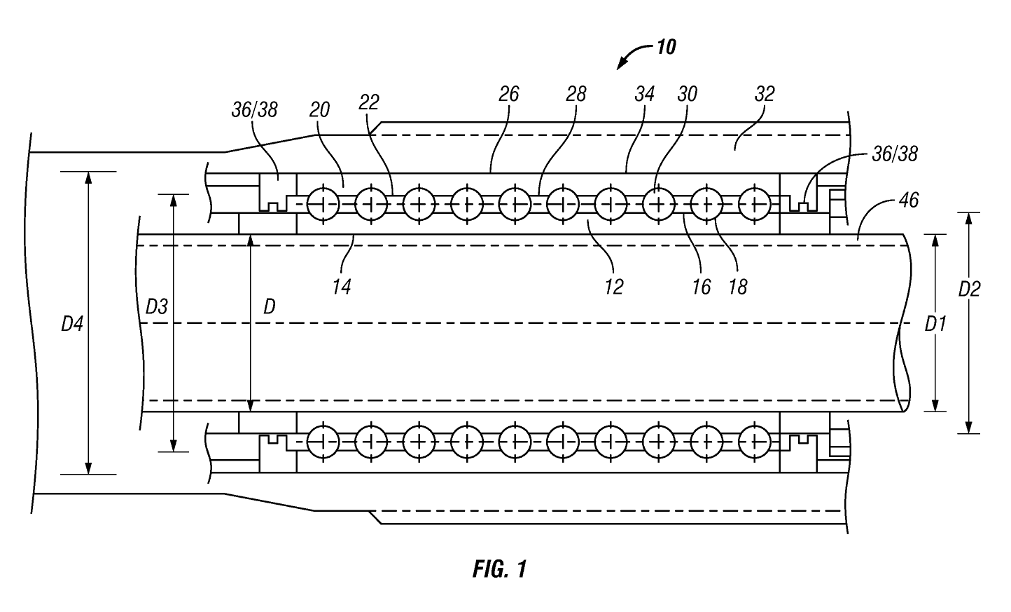

FIG. 1 shows a longitudinal sectional view of a bearing 10 according to a first embodiment of the present invention. The bearing 10 has an inner race 12 which is formed as a unitary construction of a hardened material. The inner race 12 has an inner surface 14 defining a first diameter D1 and an outer surface 16 defining an second diameter D2 and a number of race-ways 18 (ten race-ways 18 are shown in FIG. 1) are provided at axially distributed locations in the outer surface 16 of the inner race 12.

The bearing 10 also has an outer race 20 having an inner surface 22 defining a first diameter D3, an outer surface 26 defining a second diameter D4 and a number of race-ways 28 provided at axially distributed locations in the inner surface 22 of the outer race 20 (ten race-ways 24 are shown in FIG. 1).

Bearing elements, in the form of balls 30, are provided in the raceways 18, 28 to couple the inner race 12 and the outer race 20 such that, in use, the inner race 12 and the outer race 20 can rotate relative to each other.

A bearing housing 32 is provided and the outer surface 26 of the outer bearing race 20 is secured to an inner surface 34 of the housing 32.

A sealing arrangement 36 is also provided at each end of the bearing 10 and, in the embodiment shown, the sealing arrangement 36 comprises annular seal elements 38.

In use, the bearing 10 may be constructed to carry radial loading and/or uni-directional or bi-directional axial loading. The bearing system may be either drilling fluid lubricated or lubricated by lubrication oils or grease in a sealed pressure compensated environment.

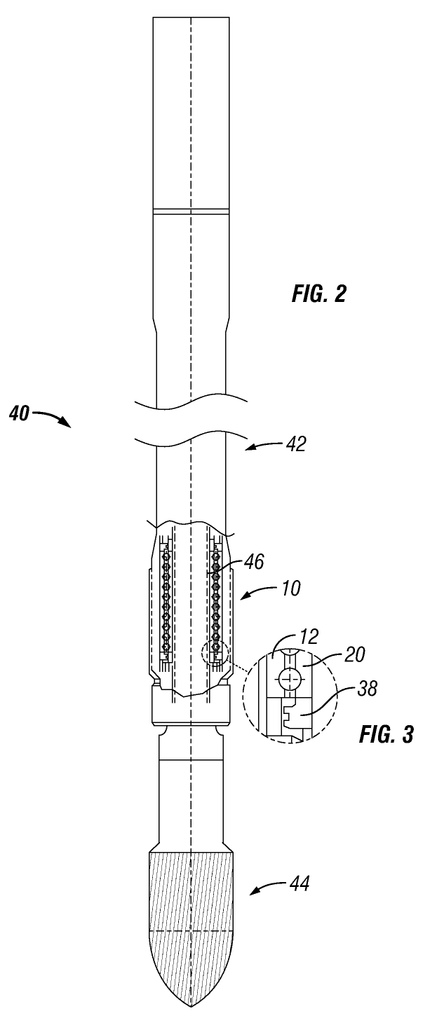

With reference now also to FIG. 2, there is shown a longitudinal sectional view of a downhole motor assembly 40 comprising the bearing 10. As shown, the bearing 10 is provided between a motor 42 and a cutting element 44, such as a drill bit or reaming tool.

On assembly, the bearing housing 32 is secured to a housing of the motor 42 and the inner surface 14 of the inner bearing race 12 is secured to a shaft 46, such as an internal power output shaft of the motor 42. The shaft 46 extends between the motor 42 and the cutting element 44, the bearing 10 supporting the shaft 46 within the bearing housing 32 and facilitating relative movement between the shaft 46 and the bearing housing 32.

The shaft 46 is adapted to be coupled to the cutting element 44 so that, in use, rotation of the shaft 46 by the motor 42 drives rotation of the cutting element 44 to cut or ream the borehole.

In embodiments of the present invention, the first diameter D1, that is the internal diameter of the inner race 12, is selected so as to be greater than a drill through diameter D, such that removal of the bearing 10 is not required when performing such a drill through operation. The inner race 12 of the bearing 10 is designed to be a rigid support conduit structure of the bearing 10 capable of maintaining the intergrity of the bearing where the shaft 46 and/or other internal components on which the inner race 12 sits are removed by a drill through operation. This, for example, prevents or at least mitigates the risk that the components of the bearing will fall into the path of the drill performing the drill through operation causing an obstruction. The provision of a unitary inner race 12 also reduces or eliminates the possibility of damage to an inner race comprising a number of individual inner race components which may occur due to rotation of the drill within the inner race, often with minimum centralising stabilisation.

Accordingly, embodiments of the present invention represent an improved bearing for a downhole drilling motor in which the bearing support structures of the inner race is outside the diameter of a drill-bit drill through diameter used to drill through the internals of the drilling motor, such as motor 42.

With reference now also to FIG. 3, end faces 37 of the inner race 12 and outer race 20 are utilised as axial support faces for use in the assembly of the assembly 40.

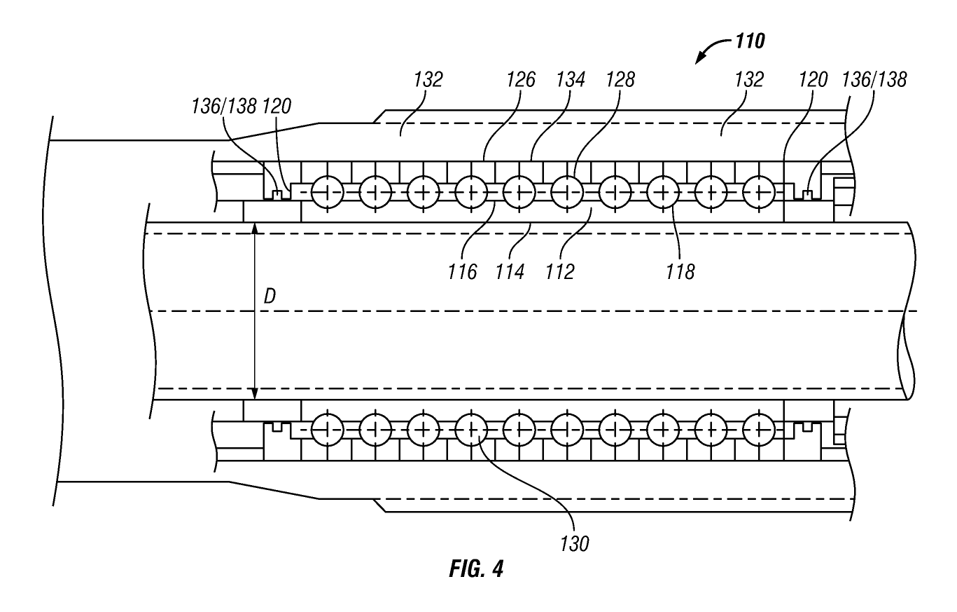

In the embodiment shown in FIGS. 1 to 3, the outer race 20 is a single unitary construction. However, in an alternative embodiment shown in FIG. 4, in which like components are represented by like numerals incremented by 100, the outer race may alternatively comprise a number of separate components.

It is to be understood that this type of arrangement could also used with roller type bearings for an axial thrust bearing, or needle roller bearings for radial journal bearings, and both axial and radial bearings be constructed for us with ceramic, polymeric, elastomeric, metallic, magnetic or PCD (poly crystalline diamond) materials.

While the invention has been described with reference to a limited number of embodiments, those skilled in the art having the benefit of this disclosure will readily be able to devise other embodiments which do not exceed the scope of the present invention. Accordingly, the invention shall be limited in scope only by the attached claims.

What is claimed is:

1. A bearing for a downhole motor assembly, the bearing comprising an inner race having an inner diameter configured so as to be outside a drill through diameter of the motor assembly.

2. The bearing of claim 1, wherein the inner race of the bearing is formed as a unitary construction.

3. The bearing of claim 1, wherein the inner race is constructed a hardened material.

4. The bearing of claim 1, wherein the inner race comprises at least one race-way.

5. The bearing of claim 1, wherein the inner race comprises a plurality of race-ways.

6. The bearing of claim 1, further comprising an outer race.

7. The bearing of claim 6, wherein the outer race comprises at least one race-way.

8. The bearing of claim 6, wherein the outer race comprises a plurality of race-ways.

9. The bearing of claim 1, wherein the bearing comprises a four point contact bearing.

10. The bearing of claim 1, further comprising a sealing arrangement for sealing the bearing.

11. The bearing of claim 10, wherein the sealing arrangement comprises a hardened seal running surface.

12. The bearing of claim 1, wherein the bearing is drilling fluid lubricated.

12. The bearing of claim 1, wherein the bearing is lubricated by lubrication oils or grease in a sealed pressure compensated environment.

13. A downhole motor assembly comprising:
a rotary drive;
a cutting element; and
a bearing the bearing comprising an inner race having an inner diameter configured so as to be outside a drill through diameter of the downhole motor assembly.

14. The assembly of claim 13, wherein the rotary drive comprises a downhole drilling motor.

15. The assembly of claim 13, wherein the rotary drive comprises a reaming motor.
